(19) United States
(12) Patent Application Publication
(10) Pub. No.: US 2018/0298603 A1
(43) Pub. Date: Oct. 18, 2018

(54) SUPPORT BRACKET

(71) Applicants: Russell Preece, Oshawa (CA); Ryan Machado, Ajax (CA)

(72) Inventors: Russell Preece, Oshawa (CA); Ryan Machado, Ajax (CA)

(21) Appl. No.: 15/625,386

(22) Filed: Jun. 16, 2017

(30) Foreign Application Priority Data
Apr. 13, 2017 (CA) 2964577

(51) Int. Cl. E04B 1/41; E04B 1/00

(52) U.S. Cl. CPC E04B 1/40; F16M 13/02; E04B 1/003

(57) ABSTRACT

A support bracket for mounting a wooden post to the foundations of a building is disclosed. The bracket includes a right angular steel member with first and second planar portions coupled together by a triangular web integrally mounted midway between the left and right side edges of the first and second planar portions. Opposite left and right wing members extend upward from the sides of the first planar portion and a plurality of faster holes are formed on the second planar portion on either side of the web.

### FIELD OF THE INVENTION

The invention relates generally to support brackets for mounting wooden posts to the foundations of a house or other building to support a deck or patio.

### BACKGROUND OF THE INVENTION

Building a patio or deck extension to a ground or upper floor of a house or building requires the mounting of several support posts to the wall of the building. To ensure that the posts closes to the house or building are secure, they ideally should be anchored to the foundation of the building by means of anchor bolts which pass through the posts and into the buildings foundation. Unfortunately, the external walls of many buildings project slightly from the foundation, often by a few inches. This is particularly the case where the external walls have siding or brick veneer. In such cases, the support posts cannot be anchored directly to the foundation because the siding or brick veneer prevents the posts to rest flush against the foundation. Where support posts cannot be mounted directly to the foundation of the building, builders most commonly secure the frame of the deck or patio to the rim joist of the exterior wall by lag bolts and position a support post some distance from the exterior wall. This is not the best solution. Suitable support brackets which allow for the direct mounting of a vertical support post to the foundation where the exterior wall has siding or brick veneer are not available.

### SUMMARY OF THE INVENTION

In accordance with one aspect of the present invention, there is provided a support bracket for mounting a wooden post to the foundations of a building which overcomes the disadvantages of prior support brackets. The support bracket of the present invention consists of a right angular bracket having a horizontal flat portion and a vertical flat portion held at a right angle to the horizontal flat portion. The horizontal and vertical flat portions each have opposite left and right side edges. The horizontal flat portion has a forward edge and the vertical flat portion has a lower edge. A triangular web is perpendicularly coupled to both the horizontal and vertical flat portions and extends mid way between the left and right side edges of both the horizontal and vertical flat portions. The triangular web has a horizontal edge coupled to the horizontal flat member, a vertical edge mounted to the vertical flat member, a transverse edge which extends from the forward edge of the horizontal flat member to the lower edge of the vertical flat member and a right angled corner which is mounted to the junction of the horizontal and vertical flat members. Right and left projecting wings are formed on the right and left side edges of the horizontal flat member, respectively, with faster holes formed on the wings to bolt to the wooden post positioned between the wings. The wings being separated from the junction of the horizontal and vertical flat members by a gap. A left and right series of fastener holes formed on the vertical flat member, the left series of fastener holes formed between the web and the left side edge and the right series of fastener holes formed between the web and the right side edge.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a support bracket made in accordance with the present invention.

FIG. 2 is a side view of the support bracket shown in FIG. 1.

FIG. 3 is a Front view of the support bracket shown in FIG. 1.

FIG. 4 is a side view of the support bracket mounting a post to a wall.

In the drawings like characters of reference indicate corresponding parts in the different figures.

### DETAILED DESCRIPTION OF THE INVENTION

Referring to FIG. 1 a support bracket made in accordance with the present invention, shown generally as item 10 and consists of an angular piece of steel having horizontal flat portion 12 and vertical flat portion 14 held at a right angle to portion 12. Portions 12 and 14 could be made from a single flat piece of steel which is bent at 90° or it could be made from two separate pieces welded together. Flat portion 12 has right side edge 16, left side edge 18, forward edge 20 and back edge 22. Left wing member 34 projects upwardly from left edge 18 and right wing member 32 projects upwardly from right edge 16. Both wing members are provided with fastener holes 38 which are dimensioned to receive a fastener such as a nail, screw or bolt for securing the end of a wooden post and holding it on top of flat portion 12. Wing 32 has front edge 31 and back edge 33 and wing 34 has front edge 35 and rear edge 37. Front edges 31 and 35 are contiguous with front edge 20. Gap 36 separates rear edges 37 and 33 from rear edge 22 of flat member 12.

Referring now to FIGS. 1, 2 and 3, web 30 is a triangular piece of steel which is welded to both flat portions 14 and 16 at the centre of both portions. Web 30 has upper horizontal edge 43 welded to flat portion 12 along its entire length at a point midway between the left and right side edges of flat portion 12. Likewise, web 30 has vertical edge 44 welded to flat portion 14 along its entire length midway between the right and left side edges of the flat portion 14. Triangular web 30 has acute corner 52 welded to portion 12 adjacent front edge 20. Triangular web 30 has acute corner 50 welded to portion 14 adjacent lower edge 28. Triangular web 30 has right angled corner 48 welded to both portions 12 and 14 at inside corner 41. Finally triangular web 30 has a transverse edge 46 which extends between lower edge 28 and forward edge 20. With triangular is welded to portions 12 and 14 continuously along the lengths of side edges 42 and 44, respectively, to create a very rigid and strong structure where forces bearing down the centre of portion 12 is transferred efficiently to the centre of portion 14 along the entire length of portion 12.

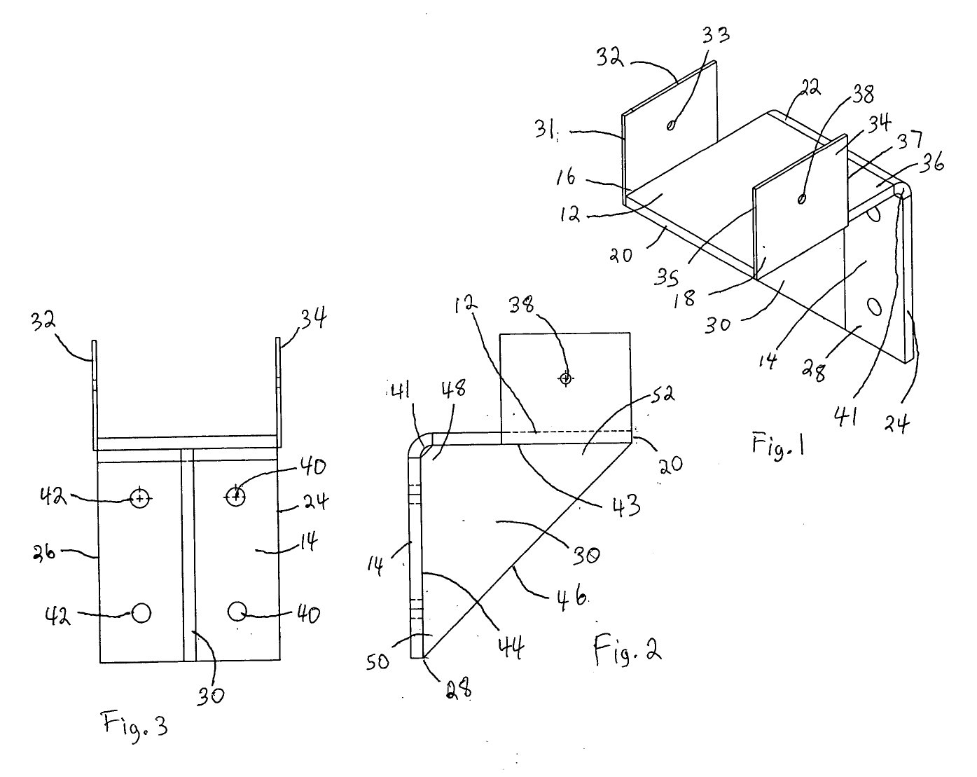

Referring now to FIG. 3, fastener holes 40 are formed in a series on the left side of portion 14 between web 30 and left side edge 24, and fastener holes 42 are formed in a series on the right side of portion 14 between web 30 and right side edge 26. Multiple fastener holes will be provided to ensure that multiple mounting bolts can be used to secure the bracket to the foundation of a building.

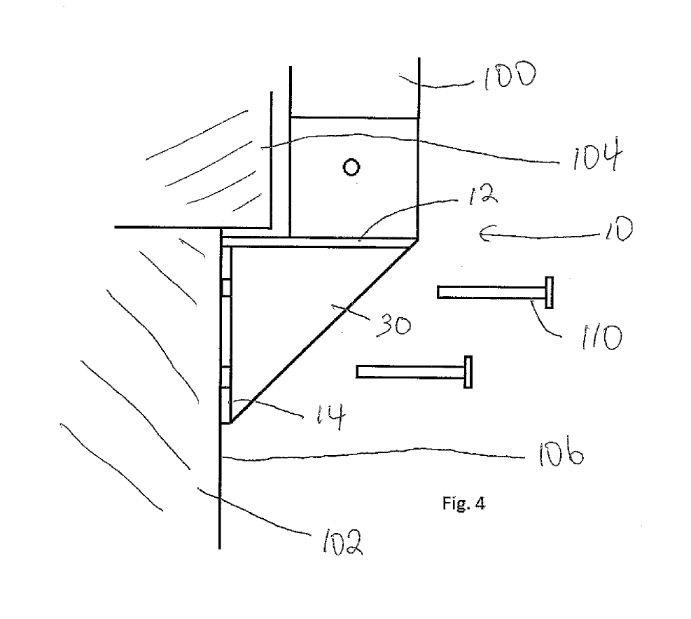

Referring now to FIG. 4, mounting bracket 10 can be used to vertically support a post 100 to the outside of a building's foundation 102. The vertical portion 14 of the bracket can be mounted directly to surface 106 of foundation 102 at a point immediately below siding 104. Since the wing portions are offset from the vertical portion at the back of the bracket, post 100 can be secured to bracket 10 while the vertical portion of the bracket makes direct contact with the foundation. Since web 30 is positioned at the very centre of the horizontal portion 12, the full weight of post 100 is transmitted from the post, to horizontal portion 12 and through web 30 to vertical portion 14. The fastener holes being positioned on vertical portion 14 on opposite sides of web 30 makes it possible for two rows of fasteners 110 to be easily attached to the vertical portion, making for a stronger attachment to foundation 102. Hence, bracket 10 effectively transmits the downward force applied to post 100 to foundation 102 through web 30 and fasteners 110.

Referring back to FIG. 1, planar portions 12 and 14 are preferably formed from a single sheet of steel between ½ to ¼ inch thick. It has been discovered that ⅜ inch thick steel is ideal because it provides adequate support and improved lightness. Web 30 is preferably between ½ to ¼ inch thick with ⅜ inch being the preferred thickness. Wing portions 32 and 34 may be of lighter gauge, say ⅛ in thickness. Web 30 is preferably welded to portions 12 and 14 to ensure a strong connection.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A support bracket for supporting and mounting a wooden post to the foundations of a building, the support bracket comprising:
a. An angular member having first and second planar portions positioned at a right angle to each other, the first planar portion having opposite left and right side edges and opposite forward edge and back side, the second planar portion depending from the back side of the first portion, the second portion having opposite right and left side edges and a lower edge, the angular steel member having a right inside corner where the first and second planar portions meet;
b. A flat triangular web portion integrally coupling the planar first and second portions of the angular steel member, the web portion having a right angled corner and first and second acute angled corners, a first edge extending from the first acute angled corner to the right angled corner, a second edge extending from the second acute corner to the right angled corner, and a third edge extending from the first acute angled corner to the second acute angled corner, the web portion being perpendicularly mounted by its first and second edges to the first and second planar portions, respectively, such that the first edge is positioned midway between the left and right side edges of the first planar portion and the second edge is positioned midway between the left and right side edges of the second planar portion and the corner portion is mounted at the inside corner;
c. The triangular web portion being dimensioned such that the third edge extends from the forward edge of the first planar portion to the lower edge of the second planar portion;
d. Opposite left and right wing members extending perpendicularly upward from the left and right sides of the first planar portion, each of the left and right wing members having a forward edge contiguous with the forward edge of the first planar portion and a rear edges separated from the back side of the first planar portion by a space, each of the left and right wing members having at least one fastener hole, and
e. The second planar portion having a left and right series of fastener holes, the left series of fastener holes formed between the web portion and left side edge, the right series of fastener holes formed between the web portion and the right side edge.

2. The support bracket of claim 1 where the first and second planar portions, the web and the left and right wing members are made of steel, the web being welded to the first and second planar portions along the first and second edges of the web, respectively.

3. The support bracket of claim 2 wherein the first and second planar portions and the web each have a thickness of between ¼ inch to ½ inch and wherein the first and second wing members have a thickness of greater than 1/16 inch.

4. The support bracket of claim 3 wherein the first planar portion has a length between the front edge and the back side of greater than six inches and the second planar portion has a length between the lower edge and the first planar portion of greater than six inches, the left and right wing members each having a height of at least 3 inches.

5. The support bracket of claim 4 wherein the right series of fastener holes consist of at least two fastener holes with a lowermost fastener hole being at least one inch from the lower edge of the second planar portion and the fastener holes are at least three inches apart, and wherein the left series of fastener holes consist of at least two fastener holes with a lowermost fastener hole being at least one inch from the lower edge of the second planar portion and the fastener holes are at least three inches apart.

6. A support bracket for supporting and mounting a wooden post to the foundations of a building, the support bracket comprising:
a. An angular member having first and second planar portions positioned at a right angle to each other, the first planar portion having opposite left and right side edges and opposite forward edge and back sides, the second planar portion depending from the back side of the first portion at a right angle to form a right inside corner where the first and second planar portions meet, the second planar portion having a lower edge and opposite left and right side edges;
b. A flat triangular web portion integrally coupling the planar first and second portions of the angular steel member, the web portion having a right angled corner and first and second acute angled corners, the web portion being perpendicularly mounted to both the first and second planar portions midway between the left and right side edges of each such that the right angled corner of the web is mounted at the inside corner, the first acute angled corner being mounted to the first planar portion adjacent the forward edge, the second acute angled corner mounted to the second planar portion adjacent the lower edge;
c. Opposite left and right wing members extending perpendicularly upward from the left and right sides of the first planar portion, each of the left and right wing members having a forward edge contiguous with the forward edge of the first planar portion and a rear edges separated from the back side of the first planar portion by a space, each of the left and right wing members having at least one fastener hole, and
d. The second planar portion having a left and right series of fastener holes, the left series of fastener holes formed between the web portion and left side edge, the right series of fastener holes formed between the web portion and the right side edge.

7. The support bracket of claim 6 where the first and second planar portions, the web and the left and right wing members are made of steel, the web being welded to the first and second planar portions along the first and second edges of the web, respectively.

8. The support bracket of claim 7 wherein the first and second planar portions and the web each have a thickness of between ¼ inch to ½ inch and wherein the first and second wing members have a thickness of greater than 1/16 inch.

9. The support bracket of claim 8 wherein the first planar portion has a length between the front edge and the back side of greater than six inches and the second planar portion has a length between the lower edge and the first planar portion of greater than six inches, the left and right wing members each having a height of at least 3 inches.

10. The support bracket of claim 9 wherein the right series of fastener holes consist of at least two fastener holes with a lowermost fastener hole being at least one inch from the lower edge of the second planar portion and the fastener holes are at least three inches apart, and wherein the left series of fastener holes consist of at least two fastener holes with a lowermost fastener hole being at least one inch from the lower edge of the second planar portion and the fastener holes are at least three inches apart.
